(19) United States
(12) Patent Application Publication
(10) Pub. No.: US 2009/0161609 A1
(43) Pub. Date: Jun. 25, 2009

(54) Automatic busy status notifications in wireless packet services sessions

(76) Inventor: Dean W. Bergstrom, West Linn, OR (US)

Correspondence Address: SHARP LABORATORIES OF AMERICA, INC., 1320 PEARL ST., SUITE 228, BOULDER, CO, 80302, US

(21) Appl. No.: 12/002,947

(22) Filed: Dec. 19, 2007

(51) Int. Cl. H04Q 7/20

(52) U.S. Cl. 370/329

(57) ABSTRACT

A method and system provide automatic busy status notifications to parties to wireless packet services sessions in the event of temporary suspension of the sessions. In one aspect, a first wireless communication device comprises a wireless interface and a processor communicatively coupled with the wireless interface, wherein in response to a voice call received on the wireless interface the processor temporarily suspends a wireless packet services session between at least a first user on the first wireless communication device and a second user on a second wireless communication device and without user intervention transmits via the wireless interface a first message adapted to notify the second user of a temporarily busy status of the first user.

### BACKGROUND OF THE INVENTION

The present invention relates to improving packet services sessions conducted between people using wireless communication devices and, more particularly, to improving the communication of busy status between people involved in wireless packet services sessions in the event of temporary suspension of such sessions.

Many wireless communication devices, such as cellular phones, support Short Message Service (SMS) messaging, circuit-switched services such as voice calls, and packet-switched services such as instant messaging (IM) and push-to-talk (PTT). Examples of such wireless communication devices are Global System for Mobile communications/General Packet Radio Services (GSM/GPRS) cellular phones, which support SMS messaging, voice calls over a circuit-switched GSM infrastructure and IM and PTT over a packet-switched GPRS infrastructure, such as an Internet Protocol (IP) network.

Many commercially available GSM/GPRS devices are “Class B” devices. Class B devices automatically suspend an active GPRS session (for example, an IM session) with another device when a GSM session is initiated on the Class B device (for example, when a voice call is received from a third party during an IM session) and automatically resume the GPRS session once the GSM session is terminated. When such a temporary suspension of an active GPRS session occurs, however, the person using the other device involved in the temporarily suspended GPRS session is not explicitly notified of the suspension. This failure to notify can lead to angst and frustration for both parties to the GPRS session that has been temporarily suspended.

### SUMMARY OF THE INVENTION

The present invention, in a basic feature, provides automatic busy status notifications in the event of temporary suspension of wireless packet services sessions.

In one aspect, a first wireless communication device comprises a wireless interface and a processor communicatively coupled with the wireless interface, wherein in response to a voice call received on the wireless interface the processor temporarily suspends a wireless packet services session between at least a first user on the first wireless communication device and a second user on a second wireless communication device and without user intervention transmits via the wireless interface a first message adapted to notify the second user of a temporarily busy status of the first user.

In some embodiments, in response to termination of the voice call the processor resumes the wireless packet services session.

In some embodiments, the first wireless communication device is a Class B cellular phone.

In some embodiments, the wireless packet services session is a GPRS session.

In some embodiments, the wireless packet services session is an IM session.

In some embodiments, the wireless packet services session is a PTT session.

In some embodiments, the first message is an SMS message addressed to the second wireless communication device. In some embodiments, the SMS message is a text message transmitted to a text message inbox on the second wireless communication device. In some embodiments, the SMS message is a text message having metadata indicating to output information from the message on the second wireless communication device in conformance with the wireless packet services session.

In some embodiments, the first message is an SMS message addressed to a server in a packet-switched infrastructure in response to which the server transmits a second message to the second wireless communication device. In some embodiments, the second message is a presence status message. In some embodiments, the second message is a wireless packet services message adapted for output on the second wireless communication device in conformance with the wireless packet services session.

In another aspect, a method for providing an automatic busy status notification in the event of temporary suspension of a wireless packet services session comprises the steps of receiving a voice call on a first wireless communication device, temporarily suspending on the first wireless communication device in response to the voice call a wireless packet services session between at least a first user on the first wireless communication device and a second user on a second wireless communication device and transmitting from the first wireless communication device in response to the voice call and without user intervention a first message adapted to notify the second user of a temporarily busy status of the first user.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication system in which the invention is operative in some embodiments.

FIG. 2 shows hardware components of a wireless communication device in some embodiments of the invention.

FIG. 3 shows functional components of a wireless communication device in some embodiments of the invention.

FIG. 4 shows a method for providing an automatic busy status notification in the event of temporary suspension of a wireless packet services session in some embodiments of the invention.

FIG. 5 shows a method for providing an automatic busy status notification in the event of temporary suspension of a wireless packet services session in other embodiments of the invention.

### DETAILED DESCRIPTION OF A PREFERRED EMBODIMENT

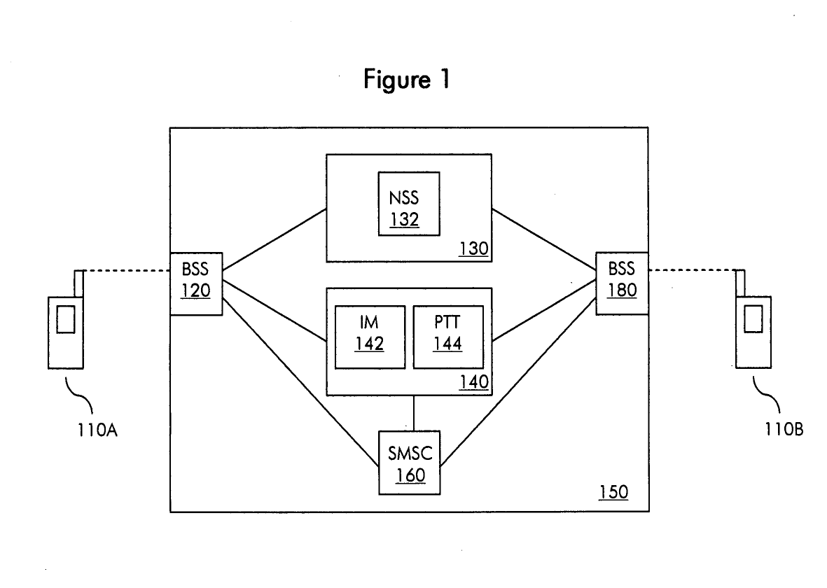

FIG. 1 shows a communication system in which the invention is operative in some embodiments. The communication system includes a first wireless communication device 110A communicatively coupled with a second wireless communication device 110B via a mobile communication infrastructure 150. Mobile communication infrastructure 150 has at its edge base station subsystems (BSS) 120 and at its core a short message service center (SMSC) 160, a circuit-switched infrastructure 1 30 and a packet-switched infrastructure 140. Circuit-switched infrastructure 130 includes a network and switching subsystem (NSS) 132. Packet-switched infrastructure 140 includes an IM server 142 and a PTT server 144. Wireless communication devices 110A, 110B communicate via circuit-switched infrastructure 130 when using circuit-switched services, such as voice calls. Wireless communication devices 110A, 110B communicate via packet-switched infrastructure 140 when using packet-switched services, such as IM and PTT. In some embodiments, circuit-switched infrastructure 140 is a GSM infrastructure and packet-switched infrastructure 140 is a GPRS infrastructure including one or more IP networks. SMS messaging via SMSC 160 is available when either circuit-switched services or packet-switched services are in use.

Wireless communication devices 110A, 110B are mobile handheld devices, such as cellular phones, operated by human users. In some embodiments, devices 110A, 110B are Class B cellular phones that automatically suspend an active GPRS session, for example an IM or PTT session, with another device when a GSM session is initiated on the phone, for example, when a voice call is received on the phone from a third party, and automatically resume the GPRS session when the GSM session is terminated.

Base station subsystems 120, 180 are wireless access points that provide wireless communication devices 110A, 110B that are in range of base station subsystems 120, 180 access to mobile communication infrastructure 150. In some embodiments, base station subsystems 120, 180 are cellular towers.

Network switching subsystem 132 includes one or more circuit-switching nodes for switching voice traffic in voice calls between wireless communication devices 110A, 110B.

SMSC 160 includes one or more servers for processing and distributing SMS messages, such as text messages, initiated by wireless communication devices 110A, 110B.

IM subsystem 142 includes one or more IM servers for processing and routing IM message packets in IM sessions conducted between wireless communication devices 110A, 110B.

PTT subsystem 144 includes one or more PTT servers for processing and routing PTT message packets in PTT sessions conducted between wireless communication devices 110A, 110B.

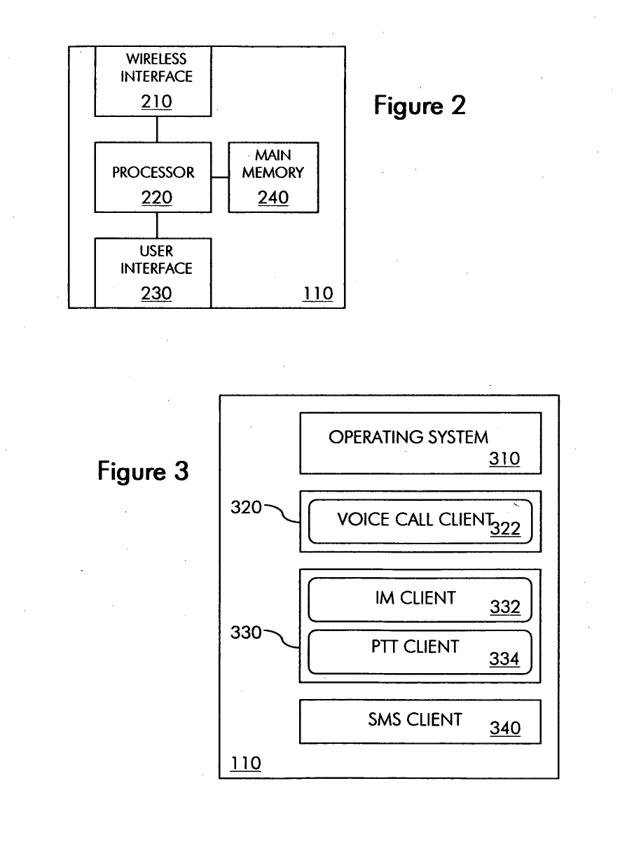

FIG. 2 shows hardware components of a wireless communication device 110, which is representative of wireless communication devices 110A, 110B, in some embodiments of the invention to include a wireless communication interface 210, a processor 220 a user interface 230 and a main memory 240. Wireless communication interface 210 is a cellular network air interface, such as a GSM/GPRS air interface, for transmitting and receiving circuit-switched and packet-switched traffic. In some embodiments, wireless communication interface 210 includes an analog-to-digital converter. Processor 220 includes a microprocessor that executes software processes stored in main memory 240. In some embodiments, processor 220 also includes custom logic, such as digital signal processor (DSP) logic. User interface 230 receives inputs and displays outputs to and from human users who operate device 110. User interface 230 may include, for example, a keypad for inputting IM messages, a liquid crystal display (LCD) screen or light emitting diode (LED) display screen for displaying IM messages, a microphone for inputting outbound PTT messages and a loudspeaker for outputting inbound PTT messages. Main memory 240 stores software processes executable by processor 220 to support functions and features supported by device 110, which include circuit-switched services and packet-switched services. Main memory 240 includes one or more random access memories (RAM) and one or more read only memories (ROM).

FIG. 3 shows functional components of wireless communication device 110. The functional components may be implemented in software stored in main memory 240 and executable by processor 220, custom logic on processor 220, or some combination thereof. The functional components include operating system 310, circuit services clients 320, packet services clients 330 and an SMS client 340.

Operating system 310 manages the resources of device 110, including facilitating actions and interactions between clients 320, 330 and 340.

Circuit services clients 320 include a voice call client 322. Voice call client 322 interoperates with interfaces 210, 230 to provide voice call functions, such as voice call establishment and tear-down, analog-to-digital conversion and digital signal processing, such as voice compression and encoding, for voice calls conducted via circuit-switched infrastructure 130. Packet services clients 330 include an IM client 332 and a PTT client 334. IM client 332 interoperates with interfaces 210, 230 to provide IM functions, such as IM session establishment through Session Initiation Protocol (SIP) signaling, IM message input/output and IM message packet formatting for IM sessions conducted via packet-switched infrastructure 140. PTT client 334 interoperates with interfaces 210, 230 to provide PTT functions, such as PTT over cellular (PoC) session establishment through SIP signaling, PTT message input/output and PTT message packet formatting in support of PTT sessions conducted via packet-switched infrastructure 140. SMS client 340 interoperates with interfaces 210, 230 to provide SMS messaging functions for SMS messages transmitted and received via SMSC 160.

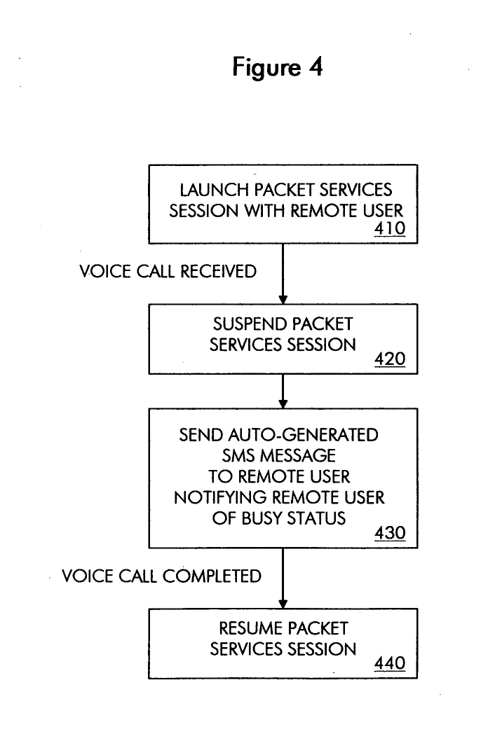

FIG. 4 shows a method for providing an automatic busy status notification in the event of a temporary suspension of a wireless packet services session in some embodiments of the invention. Initially, a user on wireless communication device 110A launches a wireless packet services session with a remote user of wireless communication device 110B (410). In some embodiments, the packet services session is an IM session launched using the IM client on device 110A and intermediated by IM subsystem 142. In other embodiments, the packet services session is a PTT session launched using the PTT client on device 110A and intermediated by PTT subsystem 144. The users of devices 110A, 110B proceed to engage in a wireless conversation in which messages are exchanged between devices 110A, 110B over packet-switched infrastructure 140.

While the packet services session is active, a voice call is received on device 110A that prompts automatic suspension of the packet services session on device 110A (420). For example, in some embodiments, upon receipt of a voice call from a third party on device 110A, the voice call client on device 110A transmits an interrupt to the operating system on device 110A that prompts the operating system to suspend an active IM session involving the IM client on device 110A while the voice call is active on the voice call client. In other embodiments, upon receipt of a voice call from a third party on device 110A, the voice call client on device 110A transmits an interrupt to the operating system on device 110A that prompts the operating system to suspend an active PTT session involving the PUT client on device 110A while the voice call is active on the voice call client.

Additionally, in response to the voice call, device 110A generates and transmits without user intervention an SMS message addressed to device 110B notifying the remote user of device 110B that the user of device 110A is temporarily busy (430). For example, in some embodiments, the operating system on device 110A prompts the SMS client on device 110A to generate and transmit via a wireless communication interface on device 110A and SMSC 160 to a text message inbox on device 110B a text message that says “I'm busy with a call.” In other embodiments, the operating system on device 110A prompts the SMS client on device 110A to generate and transmit via a wireless communication interface on device 110A and SMSC 160 to device 110B a message having metadata indicating to output the text “I'm busy with a call” on device 110B as if the text were the next IM message in a temporarily suspended IM session. In still other embodiments, the operating system on device 110A prompts the SMS client on device 110A to generate and transmit a via wireless communication interface on device 110A and SMSC 160 to device 110B a message having metadata indicating to convert the text “I'm busy with a call” to audio and output the audio on device 110B as if the audio were the next PTT message in a temporarily suspended PTT session.

Eventually, the voice call is completed, which prompts automatic resumption of the packet services session on device 110A (440). For example, in some embodiments, upon termination of a voice call with a third party, the voice call client on device 110A transmits an interrupt to the operating system on device 110A that prompts the operating system to resume a temporarily suspended IM session involving the IM client on device 110A. In other embodiments, upon termination of a voice call with a third party, the voice call client on device 110A transmits an interrupt to the operating system on device 110A that prompts the operating system to resume a temporarily suspended PTT session involving the PTT client on device 110A.

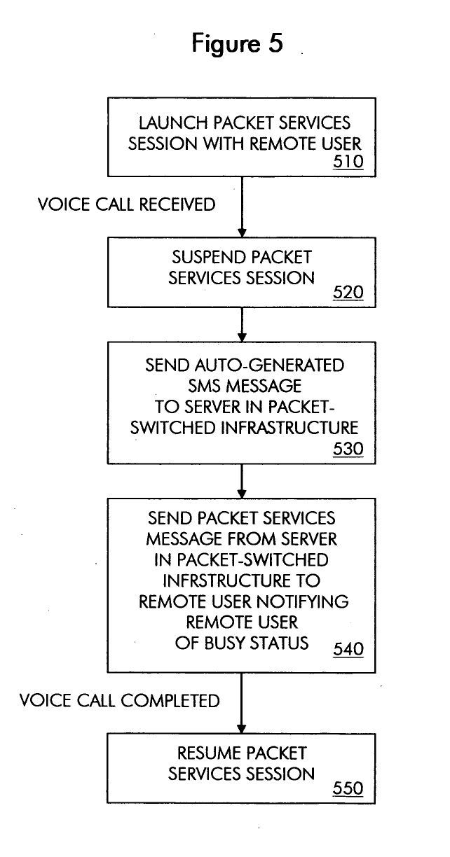

FIG. 5 shows a method for providing an automatic busy status notification in the event of temporary suspension of a wireless packet services session in other embodiments of the invention. In these embodiments, a user on wireless communication device 110A initially launches a wireless packet services session with a remote user of wireless communication device 110B (510). In some embodiments, the packet services session is an IM session launched using the IM client on device 110A and intermediated by IM subsystem 142. In other embodiments, the packet services session is a PTT session launched using the PTT client on device 110A and intermediated by PTT subsystem 144. The users of devices 110A, 110B proceed to engage in a wireless conversation in which messages are exchanged between devices 110A, 110B over packet-switched infrastructure 140.

While the packet services session is active, a voice call is received on device 110A that prompts automatic suspension of the packet services session on device 110A (520). For example, in some embodiments, upon receipt of a voice call from a third party, the voice call client on device 110A transmits an interrupt to the operating system on device 110A that prompts the operating system to suspend an active IM session involving the IM client on device 110A while the voice call is active on the voice call client. In other embodiments, upon receipt of a voice call from a third party, the voice call client on device 110A transmits an interrupt to the operating system on device 110A that prompts the operating system to suspend an active PTT session involving the PTT client on device 110A while the voice call is active on the voice call client.

Additionally, in response to the voice call, device 110A generates and transmits without user intervention an SMS message addressed to a server in packet-switched infrastructure 140 advising that the user of device 110A is temporarily busy (530), in response to which the server generates and transmits a second message to device 110B notifying the remote user that the user of device 110A is temporarily busy (540). For example, in some embodiments, the operating system on device 110A prompts the SMS client on device 110A to generate and transmit via SMSC 160 to an IM server in IM subsystem 142 or a PTT server in PTT subsystem 144 a busy status message in response to which the IM or PTT server generates and transmits a presence status message to device 110B that notifies the remote user of the busy status of the user of device 110A, for example, by displaying an indication that the user of device 110A is on the phone. In other embodiments, the operating system on device 110A prompts the SMS client on device 110A to generate and transmit via SMSC 160 to an IM server in IM subsystem 142 a busy status message in response to which the IM server generates and transmits to device 110B an IM message indicating to output the text “I'm busy with a call” on device 110B as the next IM message in a temporarily suspended IM session. In still other embodiments, the operating system on device 110A prompts the SMS client on device 110A to generate and transmit via SMSC 160 to a PTT server in PTT subsystem 142 a busy status message in response to which the PTT server generates and transmits to device 110B a PTT message indicating to output the audio “I'm busy with a call” on device 110B as the next PTT message in a temporarily suspended PTT session.

Eventually, the voice call is completed prompting automatic resumption of the packet services session on device 110A (550). For example, in some embodiments, upon termination of a voice call with a third party, the voice call client on device 110A transmits an interrupt to the operating system on device 110A that prompts the operating system to resume a temporarily suspended IM session involving the IM client on device 110A. In other embodiments, upon termination of a voice call with a third party, the voice call client on device 110A transmits an interrupt to the operating system on device 110A that prompts the operating system to resume a temporarily suspended PTT session involving the PTT client on device 110A.

In some embodiments, a wireless packet services session is considered active on a device 110A, 110B as long as the conversation screen is displayed on the user interface. In other embodiments, a wireless packet services session is considered active on a device 110A, 110B as long as device 110A, 110B has received a session message within a predetermined time. In still other embodiments, a wireless packet services session is considered active on a device 110A, 110B as long as device 110A, 110B has transmitted a session message within a predetermined time. In still other embodiments, a wireless packet services session is considered active as long as some predetermined combination of at least two of above three conditions is met.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A first wireless communication device, comprising:
a wireless interface; and
a processor communicatively coupled with the wireless interface, wherein in response to a voice call received on the wireless interface the processor temporarily suspends a wireless packet services session between at least a first user on the first wireless communication device and a second user on a second wireless communication device and without user intervention transmits via the wireless interface a first message adapted to notify the second user of a temporarily busy status of the first user.

2. The first wireless communication device of claim 1, wherein in response to termination of the voice call the processor resumes the wireless packet services session.

3. The first wireless communication device of claim 1, wherein the first wireless communication device is a Class B cellular phone.

4. The first wireless communication device of claim 1, wherein the wireless packet services session is a General Packet Radio Services (GPRS) session.

5. The first wireless communication device of claim 1, wherein the wireless packet services session is an instant messaging (IM) session.

6. The first wireless communication device of claim 1, wherein the wireless packet services session is a push-to-talk (PTT) session.

7. The first wireless communication device of claim 1, wherein the first message is a Short Message Service (SMS) message addressed to the second wireless communication device.

8. The first wireless communication device of claim 7, wherein the SMS message is a text message transmitted to a text message inbox on the second wireless communication device.

9. The first wireless communication device of claim 7, wherein the SMS message is a text message having metadata indicating to output information from the message on the second wireless communication device in conformance with the wireless packet services session.

10. The first wireless communication device of claim 1, wherein the first message is an SMS message addressed to a server in a packet-switched infrastructure in response to which the server transmits a second message to the second wireless communication device.

11. The first wireless communication device of claim 10, wherein the second message is a presence status message.

12. The first wireless communication device of claim 10, wherein the second message is a wireless packet services message adapted for output on the second wireless communication device in conformance with the wireless packet services session.

13. A method for providing an automatic busy status notification in the event of temporary suspension of a wireless packet services session, comprising the steps of:
receiving a voice call on a first wireless communication device;
temporarily suspending on the first wireless communication device in response to the voice call a wireless packet services session between at least a first user on the first wireless communication device and a second user on a second wireless communication device; and
transmitting from the first wireless communication device in response to the voice call and without user intervention a first message adopted to notify the second user of a temporarily busy status of the first user.

14. The method of claim 13, wherein the wireless packet services session is an IM session.

15. The method of claim 13, wherein the wireless packet services session is a PTT session.

16. The method of claim 13, wherein the first message a text message transmitted to a text message inbox on the second wireless communication device.

17. The method of claim 13, wherein the first message a text message having metadata indicating to output information from the message on the second wireless communication device in conformance with the wireless packet services session.

18. The method of claim 13, wherein the first message is transmitted to a server in response to which the server transmits a presence status message to the second wireless communication device.

19. The method of claim 13, wherein the first message is transmitted to a server in response to which the server transmits a second message adapted for output on the second wireless communication device in conformance with the wireless packet services session.
